(19) United States
(12) Patent Application Publication
(10) Pub. No.: US 2026/0200296 A1
(43) Pub. Date: Jul. 16, 2026

(54) Air Vent for a Vehicle

(71) Applicant: Illinois Tool Works Inc., Glenview, IL (US)

(72) Inventor: Harald Noichl, Enkenbach-Alsenborn (DE)

(21) Appl. No.: 19/439,152

(22) Filed: Jan. 2, 2026

(30) Foreign Application Priority Data
Jan. 15, 2025 (DE) 102025101216.4

(51) Int. Cl. B60H 1/34

(52) U.S. Cl. CPC B60H 1/3435; B60H 2001/3478

(57) ABSTRACT

The disclosure relates to an air vent (1) for a vehicle which is embodied as a ball vent. The air vent (1) comprises a housing (2), an insert, which is mounted such that it can be rotated and/or pivoted at least partly or in some areas about a mounting and comprises an arrangement for guiding and/or deflecting an air flow flowing through the housing (2), and an element (6) which is disposed centrally in the insert and is connected to the arrangement for guiding and/or deflecting the air flow. The arrangement for guiding and/or deflecting the air flow comprises a roller-shaped or cylinder-shaped inner air guiding element (7), wherein an air channel is formed between a lateral surface (12.2) of the inner air guiding element (7) which faces the element (6) disposed centrally in the insert and a lateral surface (13) of the element (6) disposed centrally in the insert opposite to the lateral surface (12.2) of the inner air guiding element (7). According to the disclosure, it is in particular provided that the lateral surface (12.2) of the roller-shaped or cylinder-shaped inner air guiding element (7) facing the lateral surface (13) of the element (6) disposed centrally in the insert is configured to deflect an air flow through the air channel of the element (6) disposed at least substantially centrally in the insert at least in some regions in the direction of the element (6) disposed at least substantially centrally in the insert.

### RELATED APPLICATION

The present application claims the benefit of German Patent Application No. 102025101216.4, filed Jan. 15, 2025, titled “Air Vent for a Vehicle,” the contents of which are hereby incorporated by reference.

### BACKGROUND

In ventilation apparatuses for vehicles, air vents or air vent nozzles are typically used, which enable the exiting air stream to be controlled in a targeted manner. Such air vents are used in order to supply fresh air, in particular, into a motor vehicle interior.

The air stream flows through an inlet opening at an air inlet region of the air vent into the air channel, which is delimited by the housing wall of the air vent, through said air channel, and ultimately through an outlet opening at the air outlet region of the air vent into the interior of a motor vehicle (for example, a car or truck). The air stream generally follows a main flow direction, which can run in particular at least substantially parallel to a longitudinal axis of the housing of the air vent.

In known air vents, the air stream is deflected from the main flow direction by one or more air guiding elements, for example pivotably supported air guiding blades or fixed air guiding elements. In addition to the air guiding elements, the housing of the air vent that delimits the air channel can also serve to deflect the air from the main flow direction.

A special design of air vents is in the form of corresponding “ball vents.” Here, an air guiding insert arranged in the housing of the air vent is used, wherein the air guiding insert comprises a bearing body that is pivotably supported in the housing in the manner of a ball-and-socket joint. Such ball vents can also optionally comprise an aperture mounted rotatably on the bearing body and a plurality of blades, wherein the blades can be adjusted about a pivot axis arranged radially with respect to the air guiding insert.

Such air vents, configured as ball vents, are known, for example, from DE 10 2022 131 746 A1, from DE 10 2019 003 359 A1, and EP 3 156 272 A1.

Air vents configured as ball vents have the disadvantage, due to their construction, that with the air guiding insert arranged in the housing of the air outlet, a deflection of the air flow from the main flow direction can generally only be achieved by about 18 to 20 degrees. However, larger deflections are often desired in order to specifically reach, for example, the head of the driver or passenger with the air flow exiting the air outlet. Deflections of the air flow flowing out of the air vent of about 29 degrees to 30 degrees from the main flow direction are generally desired.

Accordingly, the disclosure is based on the task of further developing an air vent that is designed as a ball vent in such a way that targeted air deflection of at least 29 degrees from the main flow direction can also be achieved even with compact design dimensions of the air vent.

### SUMMARY

The present disclosure relates generally to an air vent, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary embodiment of the air vent according to the disclosure in its neutral position.

FIG. 2 illustrates schematically, a plan view of the air outlet region of the exemplary embodiment of the air vent according to the disclosure according to FIG. 1.

FIG. 3 illustrates schematically and in an isometric view, the exemplary embodiment of the air vent according to the disclosure according to FIG. 1, however in a deflected position.

FIG. 4 illustrates schematically and in a plan view, the air outlet region of the exemplary embodiment of the air vent according to the disclosure according to FIG. 3.

FIG. 5 illustrates schematically and in a cross-sectional view, an exemplary embodiment of a conventional air vent in its neutral position.

FIG. 6 illustrates schematically, a detailed view of the air vent according to FIG. 5.

FIG. 7 illustrates schematically and in a cross-sectional view, an exemplary embodiment of the air vent according to the disclosure in its neutral position.

FIG. 8 illustrates schematically, a detailed view of the air vent according to FIG. 7.

FIG. 9 illustrates schematically and in an isometric view, the inner air guiding element (air guide ring) used in the air vent according to FIG. 5.

FIG. 10 illustrates schematically, the flow pattern of the air vent according to FIG. 5 with the inner air guiding element (air guide ring) according to FIG. 12 in a neutral position of the air vent.

FIG. 11 illustrates schematically, the flow pattern of the air vent according to FIG. 5 with an internal air guiding element (air guide ring) according to FIG. 9 in a deflected position of the air vent.

FIG. 12 illustrates schematically and in an isometric view, the inner air guiding element (air guide ring) of the air vent according to FIG. 7.

FIG. 13 illustrates schematically, the flow pattern of the air vent according to FIG. 7 with the inner air guiding element (air guide ring) according to FIG. 12 in a neutral position of the air vent.

FIG. 14 illustrates schematically, the flow pattern of the air vent according to FIG. 7 with the air guide ring according to FIG. 12 in a deflected position of the air vent.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

This problem is solved according to the disclosure by the subject-matter of independent claim 1, wherein advantageous further developments of the air vent according to the disclosure are specified in the corresponding dependent claims.

Accordingly, the disclosure relates in particular to an air vent for a motor vehicle, wherein the air vent comprises a housing with an air inlet region and an air outlet region, wherein the housing forms or comprises a channel through which air can flow. The air vent according to the disclosure further comprises an insert, which is mounted such that it can be rotated and/or pivoted at least partly or in some areas about a mounting with at least one arrangement for guiding an air flow flowing through the channel of the housing, and an element which is disposed at least substantially centrally in the insert and is connected to the at least one arrangement for guiding and/or deflecting the air flow.

The mounting is carried out in particular by means of a bearing, which is embodied such that the element disposed at least substantially centrally in the insert can be rotated, tilted, and/or pivoted relative to the housing.

The arrangement for guiding and/or deflecting the air flow comprises an inner air guiding element, which at least in regions is substantially roller-shaped or cylinder-shaped. An air channel for air flowing from the air inlet region to the air outlet region of the housing is formed between a lateral surface of the inner air guiding element facing the element disposed at least substantially centrally in the insert and a lateral surface of the element disposed at least substantially centrally in the insert opposite to the lateral surface of the inner air guiding element.

According to the disclosure, it is in particular provided in this context that the lateral surface of the at least in regions substantially roller-shaped or cylinder-shaped inner air guiding element facing the lateral surface of the element disposed at least substantially centrally in the insert is configured to deflect an air flow through the air channel between the lateral surface of the inner air guiding element and the corresponding opposite lateral surface of the element disposed at least substantially centrally in the insert at least in some regions in the direction of the element disposed at least substantially centrally in the insert.

According to embodiments of the air vent according to the disclosure, it is preferably provided in this context that the lateral surface of the at least in regions substantially roller-shaped or cylinder-shaped inner air guiding element facing the lateral surface of the element disposed at least substantially centrally in the insert is configured such that, in a neutral position of the air vent, the air flow through the air channel between the lateral surface of the inner air guiding element and the corresponding opposite lateral surface of the element disposed at least substantially centrally in the insert initially (slightly) converges in the air outlet region of the air vent and then turns into an at least substantially parallel air flow.

With this measure, better bundling of the air flow flowing out of the air outlet region of the air vent can be achieved in an easily realized but nevertheless effective manner, in particular if the air vent is in its neutral position, in which the air flow flowing through the housing of the air vent is not deflected from a main flow direction predetermined by the channel of the housing.

Better bundling of the air flow at the air outlet region of the air vent effectively prevents undesirable fanning out of the air flow flowing out of the air vent. Thus, fanning out of the air flow at the air outlet region of the housing is effectively prevented.

This bundling also has positive effects if the air vent is not in its neutral position. In particular, it has been discovered that by bundling the air flow at the air outlet region of the air vent, a significantly higher deflection of the air flow flowing out of the air vent is achievable, in particular, deflections of at least 25 degrees.

In a particularly easily realized but nevertheless effective manner, it is thus provided that the lateral surface of the at least in regions substantially roller-shaped or cylinder-shaped inner air guiding element facing the lateral surface of the element disposed at least substantially centrally in the insert is at least partly or regionally concavely curved.

By means of such a concavely curved configuration of the lateral surface of the inner air guiding element, at least the air layers adjacent to the lateral surface are deflected towards the element disposed at least substantially centrally in the insert. These deflected air layers affect the air layers located farther in the direction of the element disposed at least substantially centrally in the insert.

Alternatively or additionally, it is conceivable that the lateral surface of the at least in regions substantially roller-shaped or cylinder-shaped inner air guiding element facing the lateral surface of the element disposed at least substantially centrally in the insert comprises an in particular at least substantially edge-shaped region which projects at least partly or regionally in the direction of the lateral surface of the element disposed at least substantially centrally in the insert and is preferably formed (viewed in the main flow direction) in a downstream region of the inner air guiding element.

According to embodiments of the air vent according to the disclosure, the air vent further comprises an at least in regions substantially roller-shaped or cylinder-shaped outer air guiding element which at least partly or regionally surrounds the inner air guiding element.

In this context, it is fundamentally conceivable that the at least in regions substantially roller-shaped or cylinder-shaped outer air guiding element can be pivoted relative to the housing of the air vent about a pivot axis which extends transversely to a main flow direction specified by the channel. Of course, however, embodiments in which the outer air guiding element is not movable relative to the housing of the air vent, and in particular is designed to be pivotable, are also possible.

Optimal air guiding can particularly be achieved if a lateral surface of the at least in regions substantially roller-shaped or cylinder-shaped inner air guiding element facing a lateral surface of the at least in regions substantially roller-shaped or cylinder-shaped outer air guiding element is at least partly or regionally convex.

In particular in this context it is further conceivable that lateral surface of the at least in regions substantially roller-shaped or cylinder-shaped outer air guiding element facing the lateral surface of the at least in regions substantially roller-shaped or cylinder-shaped inner air guiding element is at least partly or regionally convexly curved.

According to embodiments of the air vent according to the disclosure, it is provided that the element disposed at least substantially centrally in the insert can be pivoted together with the at least in regions substantially roller-shaped or cylinder-shaped inner air guiding element relative to the outer air guiding element and relative to the housing about a pivot axis which extends transversely to the main flow direction specified by the channel, wherein said pivot axis extends perpendicularly to the pivot axis of the outer air guiding element.

In order to achieve a particularly compact design of the air vent, it is advantageous that a pivot and/or rotation point of the bearing coincides with an imaginary intersection point of the pivot axes of the air guiding elements.

In particular in this context, it is conceivable that the element disposed at least substantially centrally in the insert is mechanically coupled to the outer air guiding element and the inner air guiding element and, when pivoted about the bearing, causes the outer air guiding element and/or the inner air guiding element to pivot about the respective associated pivot axis.

According to embodiments of the air vent according to the disclosure, the air vent further comprises a flap arrangement with at least one flap, which is disposed pivotably within the channel to change a free cross-section of the channel.

According to further developments of the air outlet according to the disclosure, it is provided that the element disposed at least substantially centrally in the insert is coupled to a rotatable shaft and comprises a spur gear toothing which is engagement with a toothing of a drive of the flap arrangement. A rotational movement of the element disposed at least substantially centrally in the insert causes a rotational movement of the shaft and a transmission of said movement to the drive of the flap arrangement to pivot the at least one flap.

In particular, it is provided according to the disclosure that the inner air guiding element, which at least in regions is substantially roller-shaped or cylinder-shaped, is embodied as an air guide ring surrounding the element disposed at least substantially centrally in the insert.

It is thereby advantageous that the air guide ring is connected to the element disposed at least substantially centrally in the insert in such a way that rotating, tilting and/or pivoting the element disposed at least substantially centrally in the insert also rotates, tilts and/or pivots the air guide ring relative to the housing.

With respect to the element disposed at least substantially centrally in the insert, it is particularly provided that it is configured and embodied at least partly or regionally as an actuating element, in particular for manually rotating, tilting and/or pivoting the element disposed at least substantially centrally in the insert relative to the housing.

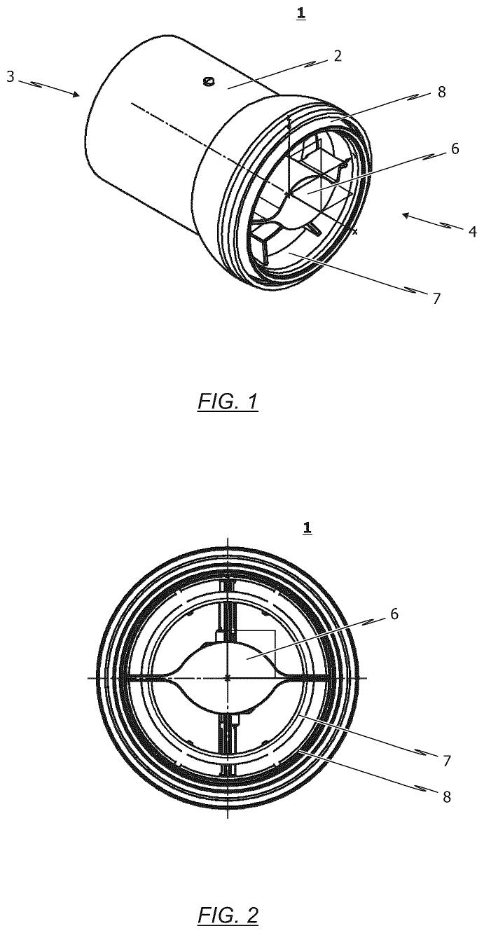

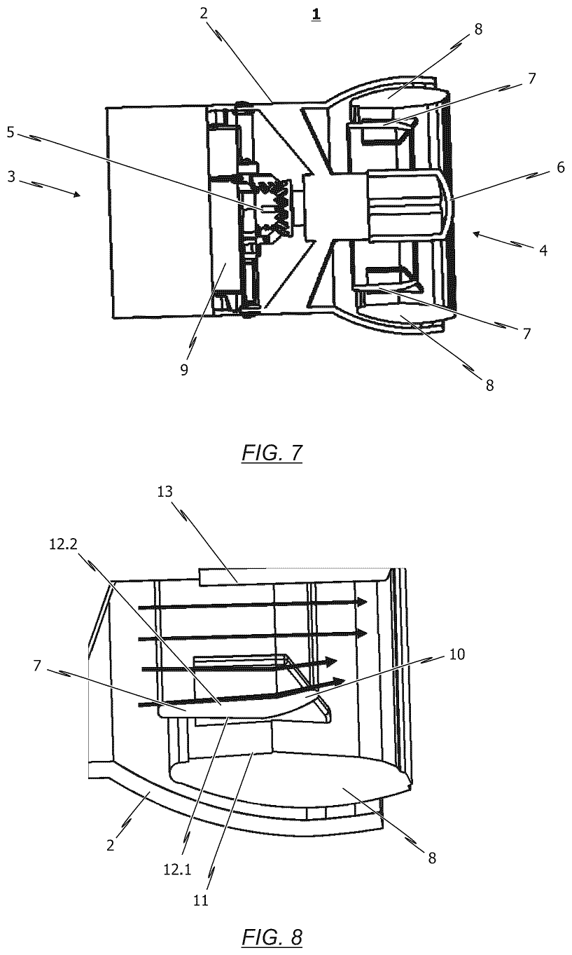

The basic construction of an air vent 1 according to the present disclosure is shown in the illustrations in FIG. 1 to FIG. 4 as well as in the cross-sectional view according to FIG. 7.

Briefly summarized, the air vent 1 shown as an exemplary embodiment in the drawings is a ball vent.

This comprises a housing 2 with an air inlet region 3 and an air outlet region 4, wherein the housing 2 forms a channel through which air can flow. In the air inlet region 3, the housing 2 may comprise at least a substantially circular cylindrical cross-section, which widens slightly conically towards the air outlet region 4. In the slightly conically flared region of the housing 2 at the air outlet region 4 of the air vent 1, an insert is located with an arrangement for guiding and/or deflecting an air flow through the channel of the housing 2.

In detail, and as can in particular be seen from the plan view of the air outlet region 4 according to FIG. 2, the insert comprises an element 6 which is disposed at least substantially centrally, which is preferably configured as an actuating element. The element 6, which is disposed at least substantially centrally in the insert, is correspondingly effectively connected to the arrangement for guiding and/or deflecting the air flow.

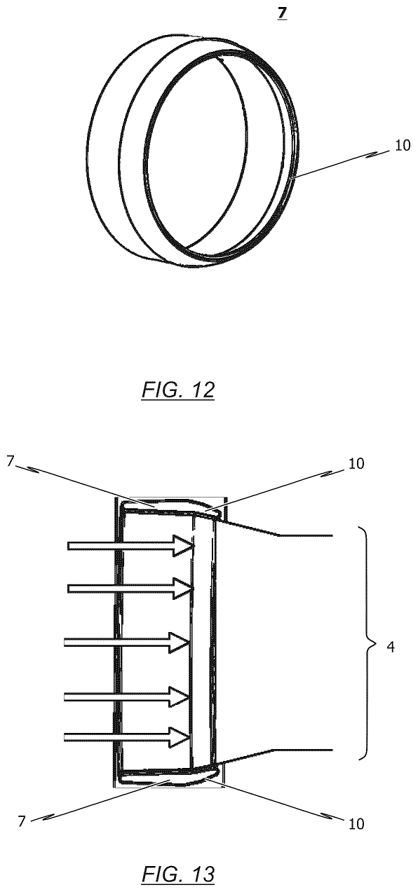

The arrangement for guiding and/or deflecting the air flow is an inner air guiding element 7, which at least in regions is substantially roller-shaped or cylinder-shaped, which—as can be seen from the isometric view according to FIG. 12—is in particular embodied as an (inner) air guide ring.

The element 6 disposed at least substantially centrally in the insert, which preferably serves as an actuating element, can be rotated, tilted and/or pivoted relative to the housing 2 of the air vent 1. A corresponding bearing 5 is used for this purpose.

In the embodiments shown in the drawings of the air vent 1 according to the disclosure, the element 6 or the actuating element disposed centrally in the insert, or the actuating element, is connected to the inner air guiding element 7, which—as described—is in particular embodied as an air guide ring, such that the inner air guiding element 7 is also rotated, tilted, and/or pivoted when the element 6 disposed centrally in the insert is rotated, tilted, and/or pivoted.

As is particularly evident from the cross-sectional view in FIG. 7 and FIG. 8., the air vent 1 further comprises an at least in regions substantially roller-shaped or cylinder-shaped outer air guiding element 8 which at least partly or regionally surrounds the inner air guiding element 7.

It is particularly provided that the at least in regions substantially roller-shaped or cylinder-shaped outer air guiding element 8 can be pivoted relative to the housing 2 about a pivot axis which extends transversely to a main flow direction specified by the channel.

The air vent 1 according to the disclosure further comprises a flap arrangement 9 with at least one flap, which is disposed pivotably within the channel to change a free cross-section of the channel. Preferably, the element 6 disposed at least substantially centrally in the insert is coupled to a rotatable shaft and comprises a spur gear toothing which is in engagement with a toothing of a drive of the flap arrangement 9, wherein a rotational movement of the element 6 disposed at least substantially centrally in the insert causes a rotational movement of the shaft and a transmission of said movement to the drive of the flap arrangement 9 to pivot the at least one flap.

The detailed view in FIG. 8 shows that a lateral surface 12.1 of the at least in regions substantially roller-shaped or cylinder-shaped inner air guiding element 7 facing a lateral surface 11 of at least in regions substantially roller-shaped or cylinder-shaped outer air guiding element 8 is at least partly or regionally convexly curved.

In addition, the lateral surface 11 of the at least in regions substantially roller-shaped or cylinder-shaped outer air guiding element 8 facing the lateral surface 12.1 of the at least in regions substantially roller-shaped or cylinder-shaped inner air guiding element 7 is at least partly or regionally convexly curved.

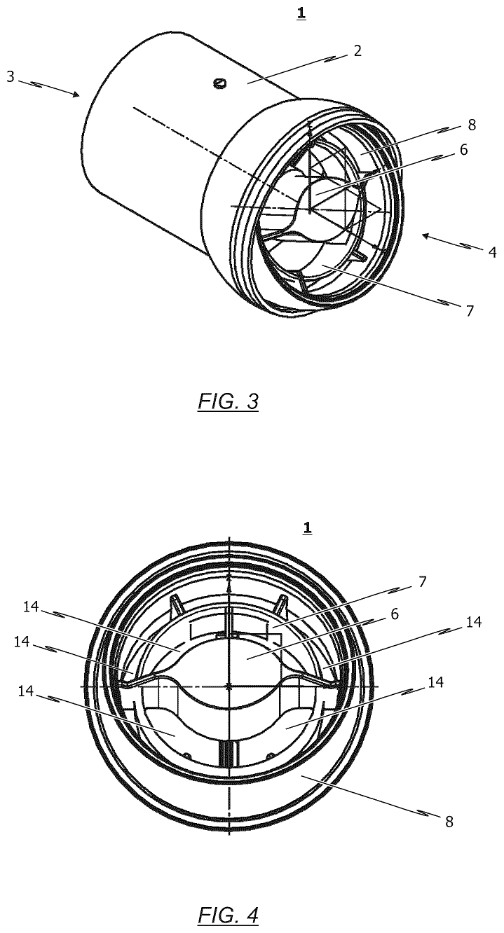

In a deflected position of the air vent 1 (cf. FIG. 3 and FIG. 4), sub-channels exist or areas 14, in which the air flowing from the air inlet region 3 to the air outlet region 4 of the housing 2 is not guided, so that air deflection of the air vent 1, which is embodied as a ball outlet, is deteriorated. These areas 14 of unguided air are indicated in FIG. 4.

By means of a particular design of the inner air guiding element 7, which is particularly embodied as an air guide ring, the negatively affected air deflection due to the areas 14 of unguided air may be equalized or compensated, as will be described in more detail below with reference to the illustrations in FIG. 5 to FIG. 14.

Specifically, in FIG. 5, a schematic view and a cross-sectional view shows a (conventional) air vent 1′ in the form of a ball vent.

Likewise, FIG. 7 shows a cross-sectional view of an exemplary embodiment of the air vent 1 according to the disclosure. In FIG. 5, and in FIG. 7, the respective air vents 1, 1′ are shown respectively in their neutral position.

With the exception of the design of the inner air guiding element 7 and the inner air guide ring, the air vents 1, 1′ shown in FIG. 5 and FIG. 7 do not differ or at least do not differ substantially.

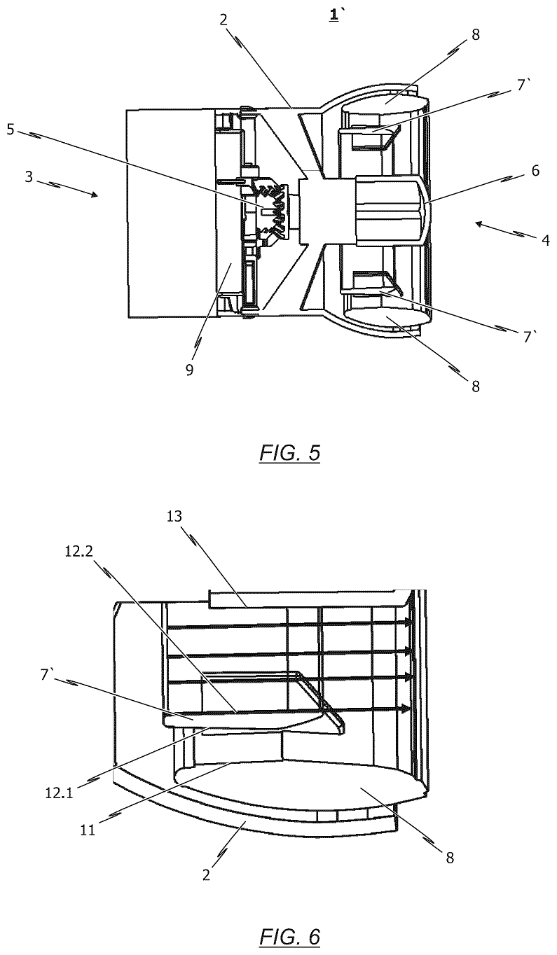

This also shows in particular the comparison of the detail views in FIG. 6 and FIG. 8. Also shown in these drawings are the flow vectors to illustrate the air flow through the air channel between a lateral surface 12.2 of the inner air guiding element 7 and a correspondingly opposite lateral surface 13 of the element 6 disposed at least substantially centrally in the insert.

In the illustration in FIG. 8, it can be seen that in the air vent 1 according to the disclosure, the lateral surface 12.2 of the inner air guiding element 7 or the inner air guide ring facing the lateral surface 13 of the element 6 disposed at least substantially centrally in the insert is designed to be at least partly or regionally concavely curved.

Alternatively or additionally, the lateral surface 12.2 of the at least in regions substantially roller-shaped or cylinder-shaped inner air guiding element 7 facing the lateral surface 13 of the element 6 disposed at least substantially centrally in the insert may comprise an in particular at least substantially edge-shaped region 10 which projects at least partly or regionally in the direction of the lateral surface 13 of the element 6 disposed at least substantially centrally in the insert and is preferably formed (viewed in the main flow direction) in a downstream region of the inner air guiding element 7.

This results in the air flow through the air channel between the lateral surface 12.2 of the inner air guiding element 7 and the corresponding opposite lateral surface 13 of the element 6 disposed centrally in the insert being deflected at least regionally towards the element 6 disposed centrally in the insert.

As a result, at least in a neutral position of the air vent 1, the air flow through the air channel between the lateral surface 12.2 of the inner air guiding element 7 and the corresponding opposite lateral surface 13 of the element 6 disposed centrally in the insert initially slightly converges in the air outlet region 4 of the air vent 1 and then turns into an at least substantially parallel air flow.

This is different from the flow field in the air outlet region 4 of the conventional air vent 1′ according to FIG. 5 and FIG. 7, as can be seen in the illustration in FIG. 10. Here, it can be seen that, in the conventional air vent 1′, the air flow diverges in the air outlet region 4.

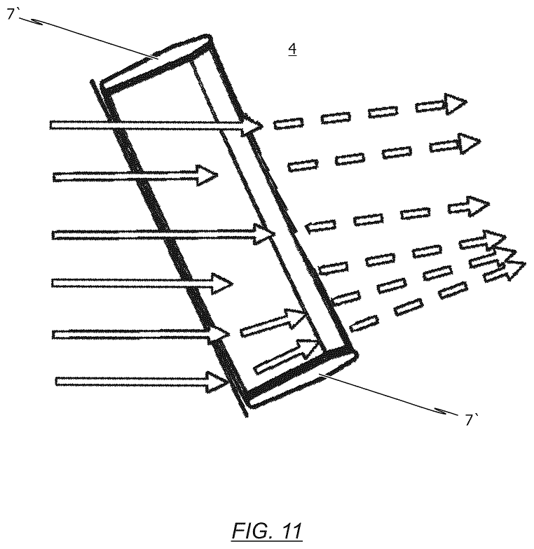

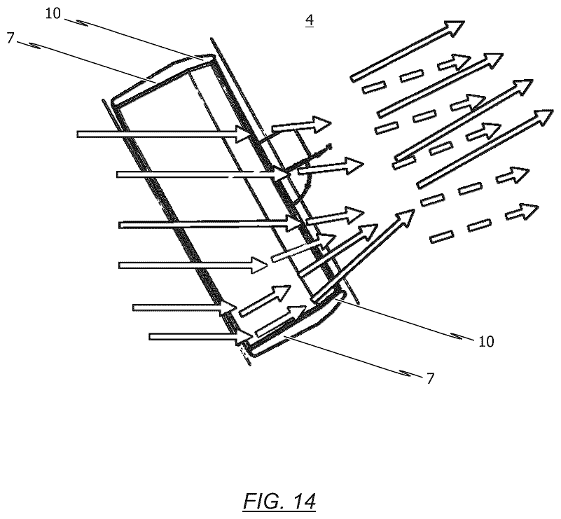

This effect is particularly significant when the corresponding air vent 1′ is no longer in its neutral position, but in a position in which the air flow is directed upwards, for example, as illustrated in FIG. 11 or FIG. 14.

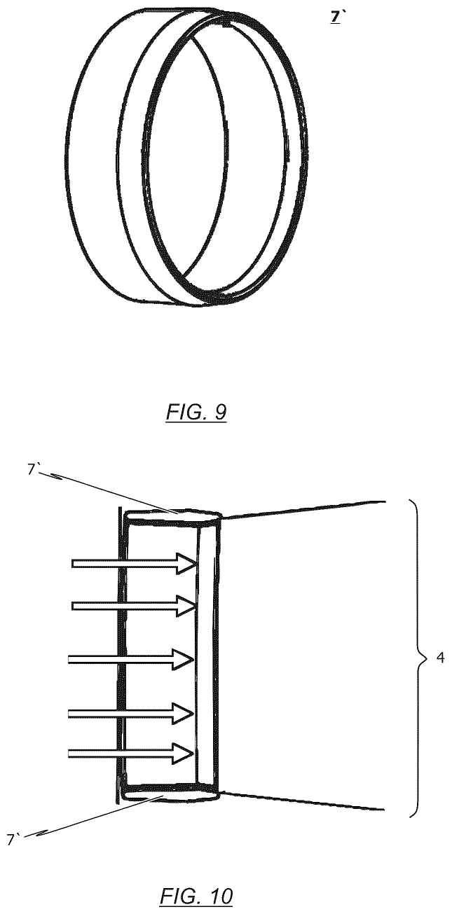

Specifically, it is shown in FIG. 11 that with the conventional design of the inner air guiding element 7′, as shown for example in an isometric view in FIG. 9, a large proportion of the air flow exits the air outlet region 4 of the air vent 1′ in an undirected manner. The undirected portion of the air flow reduces the deflection angle, because the relatively small proportion of the directed air flow does not manage to further deflect the air jet.

This is different with the new design of the inner air guiding element 7, since, with this design, the air jet is bundled more intensely and, at the exit of the air guide ring, it deflects once again more towards the center of the ring, which further deflects the remaining air flow when the air guide ring is adjusted and pushes it upwards.

The air guide ring according to the disclosure or the inner air guiding element 7 according to the disclosure serves to optimize the directability of the air flow in the case of ball vents and thus increases the efficient adjustability of the air vent 1. Particularly in the case of a relatively short downstream air guide ring, the adjustability of the air vent 1 is worsened if the air guide ring does not have the previously described configuration.

This configuration particularly comprises the lateral surface 12.2 of the at least in regions substantially roller-shaped or cylinder-shaped inner air guiding element 7 facing the lateral surface 13 of the element 6 disposed at least substantially centrally in the insert being at least partly or regionally concavely curved, and/or the lateral surface 12.2 of the at least in regions substantially roller-shaped or cylinder-shaped inner air guiding element 7 facing the lateral surface 13 of the element 6 disposed at least substantially centrally in the insert comprising an in particular at least substantially edge-shaped region 10 which projects at least partly or regionally in the direction of the lateral surface 13 of the element 6 disposed at least substantially centrally in the insert and being preferably formed (viewed in the main flow direction) in a downstream region of the inner air guiding element 7.

Thus, even with a relatively short air guide ring, optimized adjustability of the air vent 1 is ensured.

The disclosure is not limited to the embodiments shown in the drawings, but results when all of the features disclosed herein are considered together.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Air vent
1′ Conventional air vent
2 Housing
3 Air inlet region
4 Air outlet region
5 Bearing
6 Element/actuating element
7 Inner air guiding element/air guide ring
7′ Conventional inner air guiding element/air guide ring
8 Outer air guiding element
9 Flap arrangement
10 Projecting/edge-shaped region
11 Lateral surface of the outer air guiding element
12.1 First lateral surface of the inner air guiding element
12.2 Second lateral surface of the inner air guiding element
13 Lateral surface of the element/actuating element
14 Areas of unguided air

What is claimed is:

1. An air vent (1) for a vehicle, wherein the air vent (1) comprises the following:
a housing (2) with an air inlet region (3) and an air outlet region (4), wherein the housing (2) forms or comprises a channel through which air can flow;
an insert which is mounted such that it can be rotated and/or pivoted at least partly or in some areas about a mounting and comprises at least one arrangement for guiding and/or deflecting an air flow flowing through the channel of the housing (2); and
an element (6) which is disposed at least substantially centrally in the insert and is connected to the at least one arrangement for guiding and/or deflecting the air flow,
wherein the mounting is carried out by means of a bearing (5) which is embodied such that the element (6) disposed at least substantially centrally in the insert can be rotated, tilted and/or pivoted relative to the housing (2), wherein the arrangement for guiding and/or deflecting the air flow comprises an inner air guiding element (7) which at least in regions is substantially roller-shaped or cylinder-shaped, wherein an air channel for the air flowing from the air inlet region (3) to the air outlet region (4) of the housing (2) is formed between a lateral surface (12.2) of the inner air guiding element (7) facing the element (6) disposed at least substantially centrally in the insert and a lateral surface (13) of the element (6) disposed at least substantially centrally in the insert opposite to the lateral surface (12.2) of the inner air guiding element (7), wherein the lateral surface (12.2) of the at least in regions substantially roller-shaped or cylinder-shaped inner air guiding element (7) facing the lateral surface (13) of the element (6) disposed at least substantially centrally in the insert is configured to deflect an air flow through the air channel between the lateral surface (12.2) of the inner air guiding element (7) and the corresponding opposite lateral surface (13) of the element (6) disposed at least substantially centrally in the insert at least in some regions in the direction of the element (6) disposed at least substantially centrally in the insert.

2. The air vent (1) according to claim 1,
wherein the lateral surface (12.2) of the at least in regions substantially roller-shaped or cylinder-shaped inner air guiding element (7) facing the lateral surface (13) of the element (6) disposed at least substantially centrally in the insert is configured such that, in a neutral position of the air vent (1), the air flow through the air channel between the lateral surface (12.2) of the inner air guiding element (7) and the corresponding opposite lateral surface (13) of the element (6) disposed at least substantially centrally in the insert initially converges in the air outlet region (4) of the air vent (1) and then turns into an at least substantially parallel air flow.

3. The air vent (1) according to claim 1,
wherein the lateral surface (12.2) of the at least in regions substantially roller-shaped or cylinder-shaped inner air guiding element (7) facing the lateral surface (13) of the element (6) disposed at least substantially centrally in the insert is at least partly or regionally concavely curved.

4. The air vent (1) according to claim 1,
wherein the lateral surface (12.2) of the at least in regions substantially roller-shaped or cylinder-shaped inner air guiding element (7) facing the lateral surface (13) of the element (6) disposed at least substantially centrally in the insert comprises an in particular at least substantially edge-shaped region (10) which projects at least partly or regionally in the direction of the lateral surface (13) of the element (6) disposed at least substantially centrally in the insert and is preferably formed (viewed in the main flow direction) in a downstream region of the inner air guiding element (7).

5. The air vent (1) according to claim 1,
wherein the air vent (1) further comprises an at least in regions substantially roller-shaped or cylinder-shaped outer air guiding element (8) which at least partly or regionally surrounds the inner air guiding element (7).

6. The air vent (1) according to claim 5,
wherein the at least in regions substantially roller-shaped or cylinder-shaped outer air guiding element (8) can be pivoted relative to the housing (2) about a pivot axis which extends transverse to a main flow direction specified by the channel.

7. The air vent (1) according to claim 5,
wherein a lateral surface (12.1) of the at least in regions substantially roller-shaped or cylinder-shaped inner air guiding element (7) facing a lateral surface (11) of at least in regions substantially roller-shaped or cylinder-shaped outer air guiding element (8) is at least partly or regionally concavely curved.

8. The air vent (1) according to claim 5,
wherein the lateral surface (11) of at least in regions substantially roller-shaped or cylinder-shaped outer air guiding element (8) facing the lateral surface (12.1) of the at least in regions substantially roller-shaped or cylinder-shaped inner air guiding element (7) is at least partly or regionally concavely curved.

9. The air vent (1) according to claim 6, wherein the element (6) disposed at least substantially centrally in the insert can be pivoted together with the at least in regions substantially roller-shaped or cylinder-shaped inner air guiding element (7) relative to the outer air guiding element (8) and relative to the housing (2) about a pivot axis which extends transverse to the main flow direction specified by the channel, wherein said pivot axis extends perpendicular to the pivot axis of the outer air guiding element (8).

10. The air vent (1) according to claim 9,
wherein a pivot and/or rotation point of the bearing (5) coincides with an imaginary intersection point of the pivot axes of the air guiding elements (7, 8).

11. The air vent (1) according to claim 9,
wherein the element (6) disposed at least substantially centrally in the insert is mechanically coupled to the outer air guiding element (8) and the inner air guiding element (7) and, when pivoted about the bearing (5), causes the outer air guiding element (8) and/or the inner air guiding element (7) to pivot about the respective associated pivot axis.

12. The air vent (1) according to claim 1,
wherein the air vent (1) further comprises a flap arrangement (9) with at least one flap, which is disposed pivotably within the channel to change a free cross-section of the channel, wherein the element (6) disposed at least substantially centrally in the insert is preferably coupled to a rotatable shaft and comprises a spur gear toothing which is in engagement with a toothing of a drive of the flap arrangement (9), wherein a rotational movement of the element (6) disposed at least substantially centrally in the insert causes a rotational movement of the shaft and a transmission of said movement to the drive of the flap arrangement (9) to pivot the at least one flap.

13. The air vent (1) according to claim 1,
wherein the inner air guiding element (7) which at least in regions is substantially roller-shaped or cylinder-shaped is embodied as an air guide ring surrounding the element (6) disposed at least substantially centrally in the insert.

14. The air vent (1) according to claim 13,
wherein the air guide ring is connected to the element (6) disposed at least substantially centrally in the insert in such a way that rotating, tilting and/or pivoting the element (6) disposed at least substantially centrally in the insert also rotates, tilts and/or pivots the air guide ring relative to the housing (2).

15. The air vent (1) according to claim 1,
wherein the element (6) disposed at least substantially centrally in the insert is configured and embodied at least partly or regionally as an actuating element, in particular for manually rotating, tilting and/or pivoting the element (6) disposed at least substantially centrally in the insert relative to the housing (2).
